(19) United States
(12) Patent Application Publication
(10) Pub. No.: US 2006/0198155 A1
(43) Pub. Date: Sep. 7, 2006

(54) Panel mounted task light for a vehicle

(75) Inventors: Michael W. Nickola, Rochester Hills, MI (US); Richard D. Kuhl, Troy, MI (US)

Correspondence Address: REISING, ETHINGTON, BARNES, KISSELLE, P.C., P O BOX 4390, TROY, MI, 48099-4390, US

(73) Assignee: Sidler Inc., Madison Heights, MI (US)

(21) Appl. No.: 11/069,008

(22) Filed: Mar. 1, 2005

(51) Int. Cl. F21W 11/08

(52) U.S. Cl. 362/488

(57) ABSTRACT

A task light adapted to be substantially recessed within a vehicle, wherein a light source produces light and a light modifier is positioned in front of the light source to redirect at least a portion of the light therethrough to produce a beam of light in substantially the shape of a solid of revolution.

### TECHNICAL FIELD

The present invention relates generally to vehicle lighting and more particularly to task lights for a vehicle interior.

### BACKGROUND

Vehicle interior lights have traditionally been mounted on the inside of a vehicle to provide various types of illumination, such as task lighting. Task lights generally illuminate areas otherwise dark to assist vehicle occupants in locating items, reading maps, or other tasks requiring visibility. Common problems often encountered with task lights are that of flooding and glare. Flooding occurs when a light beam is uncontrollably disposed outside the desired illuminated area. In some instances, this may distract vehicle occupants or result in insufficient illumination. Glare is visual discomfort caused by visible sources or areas of luminance which are in an observer's field of view but do not assist in viewing, such as glare from an overhead light source.

One approach to provide a lighting unit for a vehicle interior involves providing a shield externally located with respect to the lighting unit to block certain portions of light rays emanating from the lighting unit. Unfortunately, however, this approach does not address the root cause of the undesirable glare or flooding of light. Rather, this approach involves using a separate blocking member or shield, which takes up significant space in the vehicle interior, adds yet another vehicle component to be made and assembled thereby increasing the expense of the vehicle, and presents an unattractive design.

Another approach to providing a reading light for a vehicle interior involves use of tandem light-modifying lenses. The tandem lens approach includes a light source, a plano-convex convergent first lens spaced a predetermined precision distance in front of the light source, and a bi-convex or Fresnel second lens spaced a predetermined precision distance in front of the first lens. Among other drawbacks, this approach requires a precision spaced tandem arrangement according to relative focal points of the lenses. In summary, this approach requires an unnecessary amount of space and quantity of components, and precision spacing of components, thereby making the approach undesirably bulky, costly, difficult to assemble, and sensitive.

For these reasons, it can be appreciated that vehicle task lights are neither fully developed for reduction of optical flooding and glare, nor for the ever-increasing demands of vehicle cost, part count, packaging, and robustness requirements present in most industries.

### BRIEF SUMMARY

A presently preferred embodiment of a task light is adapted to be at least partially positioned behind a vehicle interior panel. The task light includes a light source to produce light, and a light modifier positioned in front of the light source to redirect at least a portion of the light therethrough to produce a beam of light in substantially the shape of a solid of revolution.

### BRIEF DESCRIPTION OF THE DRAWINGS

Features and advantages of the task light will be apparent to those of ordinary skill in the art from the following detailed description of preferred exemplary embodiments and best mode of the task light and the claims, with reference to the accompanying drawings in which:

FIG. 1 is a perspective view showing a presently preferred embodiment of a task light mounted to a vehicle;

FIG. 2 is an exploded perspective view of the task light of FIG. 1;

FIG. 3 is a block diagram of a portion of the task light of FIG. 1 positioned behind a vehicle panel and emitting a light beam in substantially the shape of a solid of revolution such as a cylinder or cone;

FIG. 4 is an exploded perspective view of a second presently preferred embodiment of a task light; and

FIG. 5 is a side perspective view of the task light of FIG. 4 showing movement of an actuator and modifier relative to a bezel.

### DETAILED DESCRIPTION

In general, two illustrative presently preferred exemplary embodiments will be used to describe a task light used in a vehicle interior to provide a simple and compact design to meet the demanding vehicle cost, part count, packaging, and robustness requirements present in most industries. The invention will be described in its use in an automotive interior and specifically in an automotive interior door panel. But its nature and design make its use much more encompassing. For instance, the term “vehicle” as used herein includes cars, trucks, sport-utility vehicles, motor homes, and the like; as well as aircraft, watercraft, trains, and the like. Also, the term “interior” encompasses the interiors of all of the above named vehicles, and the term “panel” encompasses any type or shape of material, whether rigid, flexible, semi-flexible, and whether composed of plastic, metal, fabric, or any other substance. The term “task light” includes lighting for any types of tasks performed either inside or outside the vehicle.

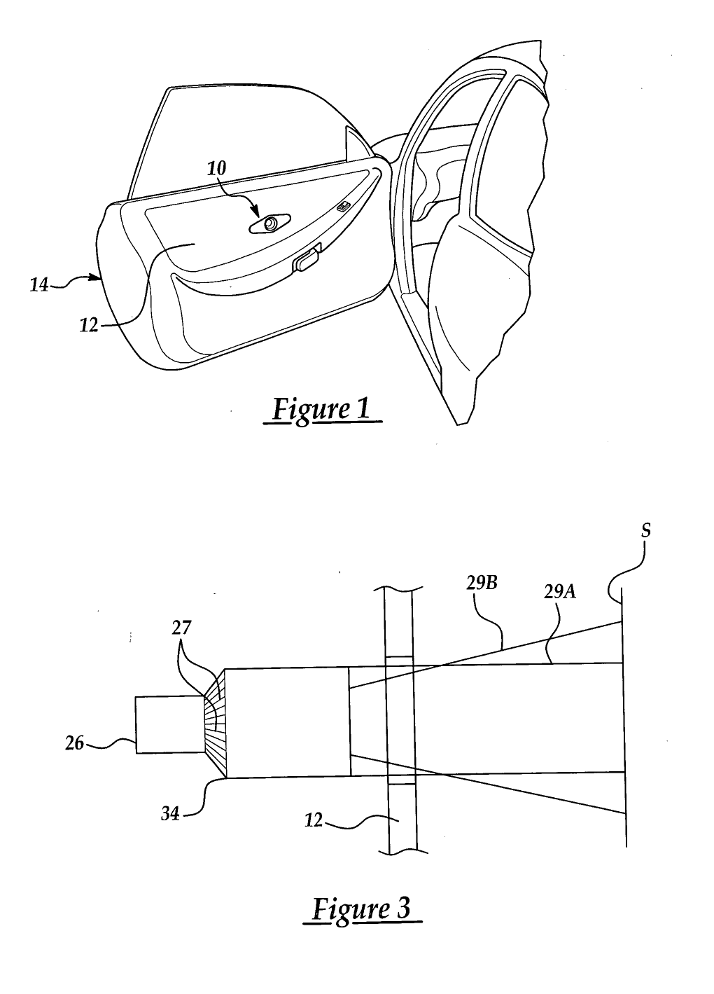

Referring specifically to FIG. 1, there is shown a task light assembly 10 for a vehicle such as an automobile and hereinafter referred to as a task light. As shown here, the task light 10 is preferably mounted to an interior panel 12 of the vehicle to provide a controlled beam of light to a vehicle occupant. Preferably, the task light 10 is mounted to an interior door panel of an automobile door 14, as shown. The task light 10 is at least partially recessed in the door 14 and, thus, mounted at least partially behind the panel 12 of the door 14 so that only a relatively small portion of it is readily apparent to vehicle occupants. In other words, the task light 10 is preferably substantially flush, or has just a portion that is slightly raised, with respect to the surface of the panel 12. The task light 10 is preferably positioned and angled so as to direct its light beam onto the lap of an occupant in a seat of the vehicle. The task light 10 is also preferably positioned at a location of the panel 12 and angled so as to direct its light beam below eye level of a vehicle driver.

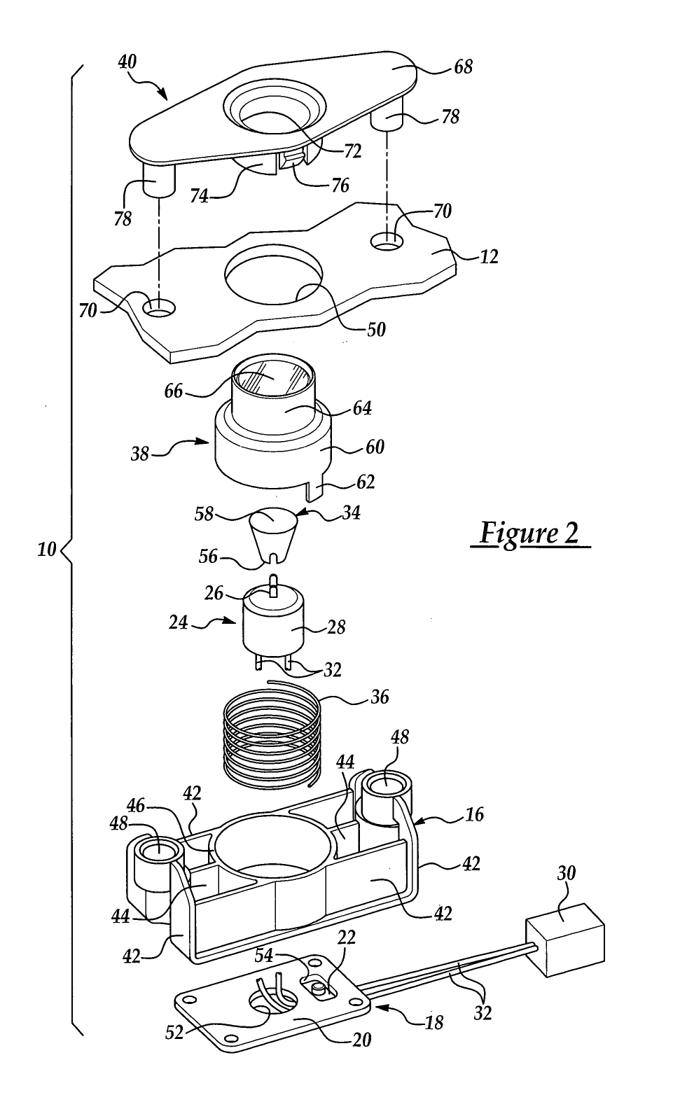

More particularly, referring now to FIGS. 2 and 3, there is specifically shown a first preferred embodiment of the task light 10, which preferably includes a structural member or housing 16 that supports an electrical subassembly 18. The electrical subassembly 18 includes a structural member such as a circuit board or plate 20 that is carried by the housing 16 in any desired manner. As part of the electrical subassembly, a switch 22 and a light source subassembly 24 are supported by the plate 20. The light-source subassembly 24 includes a light source 26 that produces light and that is supported and powered by a light source driver 28. Thus, the light source 26 is at least indirectly supported by the housing 16. The switch 22 and light source subassembly 24 are in electrical communication with an electrical connector 30 via wires 32, which are shown broken away. The task light 10 also includes a light modifier 34 that is positioned in front of the light source 26 in the general direction of light emission therefrom, and is adapted to control the shape of light emanating from the light source 26. The task light 10 also preferably includes a biasing member 36 supported within the housing 16 and other task light components to resiliently bias an actuator 38 that is also supported within the housing 16 and that provides a user interactive means to actuate the switch 22. Finally, the task light 10 includes an interior panel mounting member or bezel 40 to support the actuator 38 and provide a means to mount the housing 16 to the panel 12.

Still referring to FIG. 2, the housing 16 generally provides structural support for the various other sub-assemblies and components of the task light 10. The housing 16 may generally be produced from any suitable material using any suitable process, such as injection molding a light impermeable plastic such as a polycarbonate material, a polypropylene material, an acrylonitrile butadiene styrene (ABS) material, or any other appropriate material known to those skilled in the art. Although the housing 16 is shown as molded as a single unit, it could be molded into other separate components that are subsequently assembled or attached together. The housing 16 mounts against a rear surface of the panel 12 when installed to the vehicle and is thus hidden from vehicle occupants. The housing 16 has a somewhat rectangular and compact shape, where its overall front to back depth is substantially the same as the combined depth of the lighting subassembly 24 and light modifier 34.

The housing 16 includes side and end walls 42, interior ribs 44, a cylindrical cavity wall 46, and thru-holes 48. The four walls 42 generally define the outer boundary of the housing 16. The interior ribs 44 provide structure and stability to the housing 16 and extend from opposite walls 42 to the cavity wall 46. The cavity wall 46 defines a cavity to provide at least lateral support for the actuator 38 and the other components located therein. Accordingly, the cavity wall 46 is shaped complementary to the actuator 38; in this case barrel-shaped with an open bottom and an open top. When the housing 16 is installed or assembled to the vehicle, the cavity wall 46 generally surrounds at least a portion of the actuator 38, the biasing member 36, the lighting subassembly 24, and the light modifier 34, wherein the cavity is substantially coaxial with an opening 50 in the panel 12.

The electrical subassembly 18 includes the connector 30, the wires 32, the switch 22, the plate 20, and the lighting subassembly 24. The connector 30 may be of conventional automotive connector design and is provided to electrically couple the wires 32 via a detachable electrical connection to a power source (not shown) such as a vehicle battery (not shown). Alternatively, however, it is contemplated that the connector 30 could instead be a local power source such as a battery, wherein the task light 10 may be a self-contained drop-in assembly that needs no separate electrical connection. The wires 32 may be of conventional automotive wiring design and are provided to electrically couple the connector 30, the switch 22, and the lighting subassembly 24. The plate 20 is generally rectangular in shape with a circular aperture 52 for accepting the wires 32 therethrough and a rectangular aperture 54 for accepting a protruding actuator of the switch 22, which is mounted to an underside of the plate 20 in any suitable manner. When the task light 10 is installed or assembled, the plate 20 is preferably attached to a rear surface of the housing 16 by any conventional means such as screws (not shown), adhesive, or the like. Alternatively, the plate 20 could be an integral portion of the housing 16 if desired. Accordingly, the open bottom of the cavity is closed and covered by the plate 20 as it acts as somewhat of a rear wall for the housing 16. Both the lighting subassembly 24 and switch 22 are supported by the plate 20 such that when the plate 20 is mounted against the housing 16, the lighting subassembly 24 and switch 22 are generally located within the confines of the cavity wall 46 of the housing 16. The switch 22 is preferably a conventional automotive push-push switch to activate and deactivate the light source 26 and thus turn the task light 10 on and off.

The light driver 28 and light source 26 may also be of conventional design and construction. Preferably, the light source 26 is a single light-emitting-diode (LED), which produces light when the task light 10 is activated. It is contemplated, however, that more than one LED could be adapted for use with the task light 10. The LED can be any one of numerous types of conventional LEDs known to those persons of ordinary skill in the art, including those of various types of intensity, color, power consumption, etc. The particular type of LED will be chosen for the particular lighting application, but contemplated LED's include an LWG6SG LED from Osram®, a Lumileds® Luxeon® 1 LED, an Osram® Dragon® LED, and an Asetronics power chip LED. The LED is generally centrally located within the housing 16 and specifically located within the cavity wall 46. The LED is arranged so as to emit light through the light modifier 34 and is electrically coupled to the light source driver 28, which is preferably any suitable LED driver. Any other suitable light sources 26 and/or drivers 28 are contemplated for use with the task light 10.

The biasing member 36 is preferably a coiled compression spring composed of any suitable spring material. When the task light 10 is assembled, the spring 36 is captured and compressed between the plate 20 and the actuator 38. It is contemplated, however, that the spring 36 could be located against a portion of the housing 16, such as a narrowed cylindrical portion (not shown) of the cavity wall 46, rather than against the plate 20. In any case, the spring 36 biases the actuator 38 toward the bezel 40 and away from the plate 20.

The light modifier 34 is preferably positioned between the light source 26 and the panel 12. But the light modifier 34 may partially overlap the light source 26 and may partially protrude through the panel 12, and still meet be considered positioned between these components. Also, the light modifier 34 may preferably be interference fit to the light source 26, but may be secured thereto in any suitable fashion including with fasteners, adhesive, integral fastening features, and the like. Alternatively, the light modifier 34 need not be attached to the light source 26 and may be supported by a portion of the housing 16 such as the cavity wall 46, the actuator 38, or the like. In any case, the light modifier 34 captures light emitted from the light source 26 and produces a beam of light of predetermined shape that exits the task light 10 through the actuator 38, panel 12, and bezel 40.

The light modifier 34 may be any suitable type of optical element that produces a beam of light of predetermined shape, such as a solid of revolution like a cylinder or a truncated right circular cone. Thus, the light beam can be thought of as a type of optical solid of revolution, wherein the beam is not actually a solid but appears to take the shape of such a solid of revolution. As defined herein, the terminology “light modifier” means an element that alters distribution or composition of light by changing its direction. In other words, the light modifier substantially redirects light, and not merely permits light to pass therethrough in contrast to a simple screen. For example, the light modifier 34 may be a collimating lens, or collimator, of any one of numerous types known to those persons of ordinary skill in the art, including that disclosed in U.S. Pat. No. 6,536,923 to Merz, whose complete disclosure is incorporated by reference herein. As used herein, the term collimator means an element that produces a beam of light having light rays that emanate within a predefined conical angle, and may produce a substantially cylindrical beam of light. In another example, the light modifier 34 may be a calculated optics element, including a group of individual prisms mathematically calculated to direct light to a specific location or produce a particular light beam shape. In any case, the particular type of light modifier 34 will be chosen for the particular lighting application to produce a controlled beam of light of predetermined shape, such as a substantially collimated beam of light or a beam of light having a predetermined conical angle. The light modifier 34 is preferably of substantially conical or trapezoidal shape and preferably includes an open rear end 56 for optically cooperating with the light source 26 and an oppositely disposed closed front end 58. Regardless of the particular geometry, size, and/or composition of the light modifier 34, the light modifier 34 is preferably adapted to produce or output a controlled beam of light whose shape is predetermined within a particular useful range.

As shown in FIG. 3, the light source 26 is disposed behind the panel 12 with the light modifier 26 positioned therebetween. When activated, the light source 26 produces light 27 that is received by the light modifier 26, which then redirects at least a portion of the light 27 to produce a beam of light in substantially the shape of a solid of revolution such as a cylinder A or a truncated cone B or both. The beam of light 29 is preferably designed to illuminate a target surface a predetermined distance away from the interior surface of the panel 12.

A preferred size and shape of the frusto-conical beam of light B may be characterized by a beam having a first diameter of about 20 millimeters substantially at the exit of the task light 10 at the interior surface of the panel 12 and having a second diameter of about 300 millimeters defining a target area substantially at the target surface S, wherein the distance therebetween is preferably about twelve inches. Accordingly, the cone angle of such a beam is approximately 50 degrees (i.e. 25 degrees from central longitudinal axis to an angled side). Another preferred size and shape of a frusto-conical beam of light may be characterized by a beam having a first diameter of about 10 millimeters substantially at the exit of the task light 10 at the interior surface of the panel 12 and having a second diameter of about 300 millimeters defining a target area substantially at the target surface S, wherein the distance therebetween is preferably about three inches. Accordingly, the cone angle of such a beam is approximately 125 degrees. Both beams preferably illuminate the target area such that the average illumination of all points within the target area is no less than 50 lux and all points are preferably within ±75% of average in the target area, and the illumination of any other points outside of a 400 millimeter task zone shall not exceed 100 lux. In other words, the task light 10 does not flood a vehicle compartment with light and substantially confines its light output to a cylindrical beam or conical shape.

The actuator 38 is substantially of stepped cylindrical shape including a rear cylindrical portion 68 having a rearwardly depending projection or tang 62 and further including a front cylindrical portion 64 smaller in diameter than, and extending forward from, the rear cylindrical portion 60. The front cylindrical portion 64 includes a light transmitting screen 66 attached thereto or integral therewith. The screen 66 preferably does not focus or otherwise redirect light emanating through or from the light modifier 34. Rather, the screen 66 preferably merely covers the light modifier 34 and provides a means for a user to impart a pushing force to the actuator 38. The screen 66 may, however, be colored or tinted. It is contemplated that the screen 66 and the actuator 38 could be produced as an integral or unitary component. When installed or assembled, the actuator 38 is generally centrally located in the housing 16 within the confines of the cavity wall 46 where it generally circumferentially surrounds the light source 26 and light modifier 34. The actuator 38 is preferably loosely fitted within the housing 16 for axial or linear movement and remains axially aligned with the panel opening 50. When the actuator 38 is installed or assembled, the tang 62 is aligned over the switch 22 such that during use, it can come into direct contact with the switch 22 to provide a means for activating and deactivating the switch 22. In other words, the tang 62 is operatively associated with the switch 22 to turn the light source 26 on and off. As shown, the tang 62 is rectangular shaped and extends away from the rear cylindrical portion 60 of the actuator 38. When the task light 10 is at rest, the switch 22 is preferably not in contact with the actuator 38.

Finally, the bezel 40 is mounted against a front surface of the panel 12 and is thus partially exposed to vehicle occupants. The bezel 40 is preferably mounted flush or slightly raised with respect to the front surface of the panel 12. As such, the bezel 40 is designed with aesthetics in mind. In this example, the bezel 40 is shaped as a somewhat oblong oval with a generally planar face or wall 68. The wall 68 has an over-sized or overhanging periphery that acts as a so-called “beauty-flange” to hide panel openings 50, 70 used for installing the bezel 40. The wall 68 includes an opening 72 in a front surface thereof, a semi-cylindrical extension 74 projecting from a rear surface, one or more clips 76 projecting from the rear surface to retain the panel 12 between the rear surface of the bezel 40 and barbs that terminate the clips 76, and laterally opposed integrally formed legs 78 extending from the rear surface. A beam of light is emitted from the light source 26, through the light modifier 34 and screen 66, through the opening 50 of the panel 12, and exits through the opening 72 in the wall 68 of the bezel 40. The opening 72 is preferably in the shape of a circle but could be another shape including an oval, rectangle, or the like. The opening 72 is centrally located but may be positioned where at least some emitted light can exit it.

The legs 78 are used to attach the bezel 40 to the housing 16, wherein the legs 78 are cylindrically shaped, project through corresponding openings in the panel 12 when the bezel 40 is installed to the panel 12, and may include internal threads (not shown). The panel openings 70 are shaped complementary to the legs 78 or vice-versa, and they are dimensioned to be slightly larger than the legs 78 and are aligned therewith. The legs 78 are adapted for insertion into the through holes 48 of the housing 16. Installation screws (not shown) can be used to secure the bezel 40 to the housing 16. Otherwise, attachment members (not shown) can be press-fit into the legs 78 for securement, or integral fastening features may be used to attach the bezel 40 to the housing 16. When installed, the cylindrical extension 74 is fitted through the panel opening 50 to help locate and secure the bezel 40 to the panel 12. The cylindrical extension 74 projects from the rear surface of the wall 68 and is shaped similarly to the opening 50, in this case a circle. The extension 74 preferably projects to a distance greater than the thickness of the panel 12. The mounting clips 76 secure the wall 68 to the panel 12 and may be conventional securement devices that are known to those skilled in the art. Accordingly, the bezel 40 provides a means to at least indirectly mount the light source 26 to the panel 12, via one or more structural members such as the plate 20 and/or the housing 16.

In an alternative arrangement not shown in the drawing figures, a housing may be mounted against the rear surface of the panel 12 and attached to bosses extending therefrom. The bosses may extend through mounting holes of the housing for integral attachment, or fasteners may extend through the mounting holes for fastening the housing to the bosses, or the like. In other words, the bezel 40 need not be have the elliptical shape as shown with the legs 78 extending through the panel to support the housing. Rather, an alternative bezel could be a cylindrically shaped element that is snap fit to the panel 12 or extended through the panel and snap fit to the housing or the like.

In another alternative arrangement not shown in the drawing figures, a housing may be a substantially annular component having a rear end with snap fit projections extending therefrom for snap fit fastening to a circuit board or circuit board support member. The housing extends forward from the circuit board and, as with the previous arrangements, the housing substantially circumscribes the light modifier and spring and terminates in a front end having an internal annular lip. An annular shaped bezel has a flange positioned against the front surface of the panel and a plurality of snap fit projections extending rearwardly from the flange for snap fitting to the internal annular lip of the front end of the housing. Accordingly, the panel is sandwiched between the flange of the bezel and the front end of the housing, wherein the bezel and housing are supported by the panel.

In a further alternative arrangement, a task light may include a movable bug eye lens adapted for use as either a push screen and/or a housing for carrying one or more of a light source, light source driver, and light modifier. In this way, the task light produces a beam of light in substantially the shape of a solid of revolution, wherein the beam may be redirected by adjusting the position of the bug eye.

In use, a vehicle occupant can turn the task light 10 on and off simply by pressing a finger against the screen 66. The occupant presses the screen 66 to overcome the bias force of the coil spring 36 and displace the actuator 38 toward the plate 20 wherein the tang 62 engages the push-push switch 22 to either activate or deactivate the light source 26. When released, the spring 36 forces the actuator 38 back to its original and resting position.

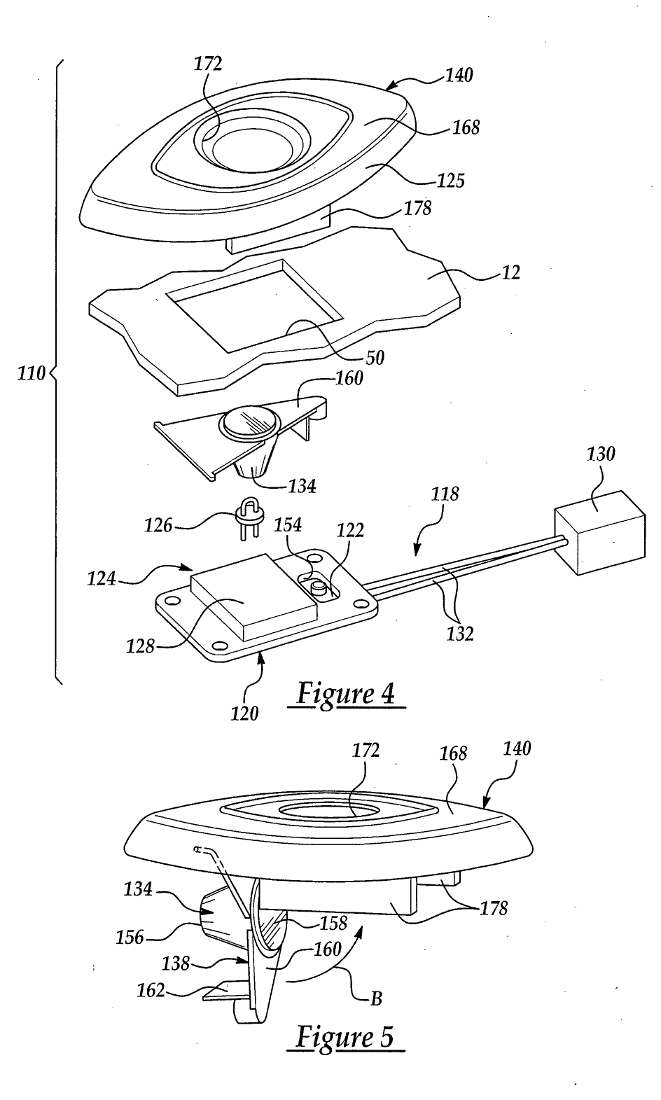

FIGS. 4 and 5 illustrate another presently preferred embodiment of a task light 110. This embodiment is similar in many respects to the embodiment of FIGS. 1 through 3 and like numerals between the embodiments generally designate like or corresponding elements throughout the several views of the drawing figures. Additionally, the description of the common subject matter will generally not be repeated here.

FIG. 4 illustrates a task light 110 which preferably includes an electrical subassembly 118 that includes a circuit board or plate 120. As part of the electrical subassembly, a switch 122 and a light source subassembly 124 are supported by the plate 120. The light-source subassembly 124 includes a light source 126 supported and powered by a light source circuit or driver 128. The driver 128 may also serve as a circuit board and/or structural member. The switch 122 and light source subassembly 124 are in electrical communication with an electrical connector 130 via wires 132. The task light 110 also includes a light modifier 134 that is adapted to substantially collimate or control the shape of light emanating from the light source 126. The task light 110 also preferably includes an actuator 138 that supports the light modifier 134 and provides a user interactive means to actuate the switch 122. Finally, the task light 110 includes an interior panel mounting member or bezel 140 to pivotably support the actuator 138 and provide a means to mount the plate 120 and, thus, the light source 126, to the panel 12.

The electrical subassembly 118 includes the connector 130, the wires 132, the switch 122, the plate 120, and the lighting subassembly 124. The connector 130 may be of conventional automotive connector design and is provided to electrically couple the wires 132 via a detachable electrical connection to a power source (not shown) such as a vehicle battery (not shown). Alternatively, however, it is contemplated that the connector 130 could instead be a local power source such as a battery, wherein the task light 110 may be a self-contained drop-in assembly that needs no separate electrical connection. The wires 132 may be of conventional automotive wiring design and are provided to electrically couple the connector 130, the switch 122, and the lighting subassembly 124. The plate 120 is generally rectangular in shape with a circular aperture (not shown) for accepting the wires 132 therethrough to connect to the driver 128 and a rectangular aperture 154 for accepting a protruding actuator of the switch 122, which is mounted to an underside of the plate 120. Both the lighting subassembly 124 and switch 122 are supported by the plate 120. The switch 122 is preferably a conventional automotive push-push switch to activate and deactivate the light source 126 and thus turn the task light 110 on and off.

The light driver 128 and light source 126 may also be of conventional design and construction. Preferably, the light source 126 is a single LED, but more than one LED could be adapted for use with the task light 110. The LED can be any one of numerous types of conventional LEDs known to those persons of ordinary skill in the art, including those of various types of intensity, color, power consumption, etc, and the particular type of LED will be chosen for the particular lighting application. The LED is arranged so as to emit light through the light modifier 134 and is electrically coupled to the light source driver 128, which is preferably any suitable LED driver. Any other suitable light sources 126 and/or drivers 128 are contemplated for use with the task light 110.

The light modifier 134 is preferably interference fit to the actuator 138, but may be secured thereto in any suitable fashion including with fasteners, adhesive, integral fastening features, and the like. Alternatively, the light modifier 134 need not be separately attached to the actuator 138, but may be an integral portion of the actuator 138, such as if the actuator and light modifier 134 were molded as a unitary piece. In any case, the light modifier 134 captures light emitted from the light source 126 and produces a beam of light that exits the task light 110 through the panel 12 and bezel 140. The light modifier 134 is preferably of substantially conical or trapezoidal shape and preferably includes an open rear end 156 for optically cooperating with the light source 126 and an oppositely disposed closed front end 158.

As depicted in FIG. 5, the actuator 138 is substantially a cantilevered arm that is pivotably mounted to an inside portion of the bezel 140. The actuator includes planar arm portion 160 having a rearwardly depending projection or tang 162. The planar arm portion 160 is adapted to carry the light modifier 134. When the actuator 138 is assembled to the bezel 140 and the task light 110 is installed to the panel 12, the tang 162 is aligned over the switch 122 such that during use, it can come into direct contact with the switch 122 to provide a means for activating and deactivating the switch 122. In other words, the tang 162 is operatively associated with the switch 122 to turn the light source 126 on and off. As shown, the tang 162 is rectangular shaped and extends away from the arm portion 160 of the actuator 138. When the task light 110 is at rest, the switch 122 is preferably in contact with the actuator 138, such that the inherent spring force of the switch 122 biases the actuator 138 away from the plate 120.

Finally, the bezel 140 is mounted against a front surface of the panel 12 and is thus partially exposed to vehicle occupants. The bezel 140 is preferably mounted flush or slightly raised with respect to the front surface of the panel 12. As such, the bezel 140 is designed with aesthetics in mind. In this example, the bezel 140 is shaped as a somewhat oblong eye-shaped oval with a generally planar face or wall 168. The wall 168 has an over-sized or overhanging periphery that acts as a so-called “beauty-flange” to hide a panel opening 50 used for installing the bezel 140. The wall 168 includes an opening 172 in a front surface thereof, a pair of opposed rectangular legs 174 extending from the rear surface thereof. The legs 174 are used to attach the bezel 140 to a structural member such as the plate 120 or the driver 128, wherein the legs 174 project through the opening 50 in the panel 12 when the bezel 140 is installed to the panel 12. The legs 174 are adapted for snap fit insertion over the plate 120 or driver 128.

In use, a vehicle occupant can turn the task light 110 on and off simply by pressing a finger against the light modifier 158. The occupant presses the closed end 158 of the light modifier 158 to overcome the inherent bias force of the push-push switch 122 and pivotably displace the actuator 138 wherein the tang 162 engages the push-push switch 122 to either activate or deactivate the light source 126. When the occupant removes their finger, thereby releasing the light modifier 158, the inherent spring force of the push-push switch 122 forces the actuator 138 back to its original and resting position. A beam of light is emitted from the light source 126, through the light modifier 134 and exits through the opening 50 of the panel 12 and through the opening 172 in the wall 168 of the bezel 140. The opening 172 is preferably in the shape of an oval but could be another shape including a circle, rectangle, or the like.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Moreover, directional words such as top, bottom, rear, front, upper, lower, radial, circumferential, lateral, longitudinal, vertical, horizontal, and the like are employed by way of description and not limitation. Other terms are to be construed using their broadest reasonable meaning unless they are used in a context that requires a different interpretation. When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

The present invention has been disclosed in conjunction with a limited number of presently preferred exemplary embodiments, but many others are possible and it is not intended herein to mention all of the possible equivalent forms and ramifications of the present invention. Other modifications, variations, forms, or ramifications will readily suggest themselves to persons of ordinary skill in the art in view of the foregoing description, and will fall within the scope of the following claims. In other words, the teachings of the present invention encompass many reasonable substitutions or equivalents of limitations recited in the following claims. For example, the disclosed structure, materials, sizes, shapes, and the like could be readily modified or substituted with other similar structure, materials, sizes, shapes, and the like. Indeed, the present invention is intended to embrace all forms, ramifications, modifications, variations, substitutions, and/or equivalents as fall within the spirit and broad scope of the following claims.

1. A task light adapted to be at least partially positioned behind a vehicle interior panel, said task light comprising:
a light source to produce light; and
a light modifier positioned in front of said light source to redirect at least a portion of said light therethrough to produce a beam of light in substantially the shape of a solid of revolution.

2. The task light of claim 1 further comprising:
a light switch electrically coupled to said light source to control operation of said light source;
at least one structural member positioned behind said vehicle interior panel and adapted to at least indirectly support said light source and said light switch; and
an actuator having a portion adapted to contact said light switch and being adapted to be pressed to control operation of said task light.

3. The task light of claim 2 wherein said actuator generally surrounds said light source and includes a screen that is adapted to be pressed.

4. The task light of claim 2 further comprising:
a bezel positioned in front of said vehicle interior panel and adapted to be attached to said at least one structural member.

5. The task light of claim 4 wherein said actuator is at least one of pivotably mounted to said bezel and adapted to carry said light modifier.

6. The task light of claim 1 wherein said light modifier is a collimator.

7. The task light of claim 1 wherein said light source is a light-emitting-diode and said light modifier is mounted thereto.

8. The task light of claim 1 being at least partially recessed in a vehicle door.

9. The task light of claim 1 further comprising:
at least one structural member positioned behind said vehicle interior panel and adapted to at least indirectly support said light source; and
a bezel positioned in front of said vehicle interior panel and adapted to be attached to said at least one structural member, wherein said light source is positioned between said at least one structural member and said bezel.

10. A task light adapted to be mounted to an interior vehicle panel having a front surface and a rear surface and at least one opening therethrough, said task light comprising:
a bezel positioned against the front surface of said vehicle panel;
a light source positioned behind said vehicle panel and adapted to produce light, said light source being at least indirectly mounted to said panel by said bezel; and
a light modifier positioned in front of said light source to redirect at least a portion of said light therethrough to produce a beam of light in substantially the shape of a solid of revolution.

11. The task light of claim 10 further comprising:
a light switch electrically coupled to said light source to control operation of said light source;
at least one structural member positioned behind said vehicle interior panel and adapted to at least indirectly support said light source and said light switch; and
an actuator having a portion adapted to contact said light switch and being adapted to be pressed through said bezel to control operation of said task light.

12. The task light of claim 11 wherein said actuator generally surrounds said light source and includes a screen that is adapted to be pressed.

13. The task light of claim 11 wherein said actuator is at least one of pivotably mounted to said bezel and adapted to carry said light modifier.

14. The task light of claim 10 wherein said light modifier is a collimator.

15. The task light of claim 10 wherein said light source is a light-emitting-diode and said light modifier is mounted thereto.

16. The task light of claim 10 being at least partially recessed in a vehicle door and positioned to direct said beam of light below an eye level of a vehicle driver.

17. A task light adapted to be at least partially recessed in a vehicle door and mounted to an interior door panel having a front surface and a rear surface and at least one opening therethrough, said task light comprising:
a bezel adapted to be positioned against the front surface of said vehicle panel;
at least one structural member positioned behind said vehicle interior panel and adapted to be attached to said bezel;
a light source positioned between said structural member and said bezel and adapted to produce light;
a light modifier positioned in front of said light source to redirect at least a portion of said light therethrough to produce a beam of light in substantially the shape of a solid of revolution;
a light switch electrically coupled to said light source to control operation of said light source; and
an actuator having a portion adapted to contact said light switch and being adapted to be pressed to control operation of said task light.

18. The task light of claim 17 wherein said actuator generally surrounds said light source and includes a screen that is adapted to be pressed.

19. The task light of claim 17 wherein said actuator is at least one of pivotably mounted to said bezel and adapted to carry said light modifier.

20. The task light of claim 17 wherein said light source is a light-emitting-diode and said light modifier is at least one of a collimator and mounted to said light-emitting-diode.
